(19) United States
(12) Patent Application Publication
(10) Pub. No.: US 2014/0092055 A1
(43) Pub. Date: Apr. 3, 2014

(54) Apparatus and associated methods

(71) Applicant: Nokia Corporation, (US)

(72) Inventors: Zoran Radivojevic, Cambridge (GB); Anton Fahlgren, San Francisco, CA (US); Paul Beecher, Cambridge (GB); Chris Bower, Ely (GB)

(73) Assignee: Nokia Corporation, Espoo (FI)

(21) Appl. No.: 13/633,398

(22) Filed: Oct. 2, 2012

(51) Int. Cl. G06F 3/0354

(52) U.S. Cl. CPC G06F 3/03545
USPC 345/174

(57) ABSTRACT

An apparatus including a shaft configured to be gripped by a user to provide input to a touch input panel; and a tip located at an interacting end of the apparatus for interacting with the touch input panel, the tip including an electrically conductive element and an electrically insulating material, the electrically insulating material configured to capacitively decouple the electrically conductive element from the shaft and/or user, wherein the electrically conductive element is configured to couple capacitively to an electrotactile electrode of the touch input panel when the electrically conductive element is in proximity to the electrotactile electrode, capacitive coupling between the electrically conductive element and the electrotactile electrode creates vibrations in the tip to cause a variation in the frictional force between the tip and the touch input panel as perceived by a user gripping the shaft during relative lateral movement of the tip and touch input panel.

### TECHNICAL FIELD

The present disclosure relates to the field of electrotactile feedback, associated methods and apparatus, and in particular concerns a touch input stylus configured to enable the perception of virtual texture on the surface of a touch input panel. Certain disclosed example aspects/embodiments relate to portable electronic devices such as desktop, laptop and tablet computers, mobile phones, personal digital assistants (PDAs), and any other electronic devices which comprise a touch input panel.

The electronic devices/apparatus according to one or more disclosed example aspects/embodiments may provide one or more audio/text/video communication functions (e.g. tele-communication, video-communication, and/or text transmission, Short Message Service (SMS)/Multimedia Message Service (MMS)/emailing functions, interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Haptic feedback technology takes advantage of a user's sense of touch by applying forces, vibrations, and/or motions upon the user to convey information. This technology has previously been used to assist in the creation and control of virtual objects (i.e. objects existing only in a computer simulation) and to enhance control of remote machines and devices.

More recently, however, haptic feedback has been used in portable electronic devices to supplement visual content. For example, some devices use haptic feedback to produce vibrations in response to touch. This may be combined with touch-sensitive screens where the vibrations can be used to acknowledge selection of on-screen content by the user. In other devices, vibrations have been used to direct a user to a particular on-screen feature, and even to create a tactile representation of an image to enable perception of displayed content with reduced cognitive effort.

There are several emerging technologies aiming to introduce haptic feedback without mechanically moving parts. One of these is an electrotactile surface which takes advantage of direct capacitive coupling to a user's skin to create a variable frictional force on the touchscreen panel. This variable frictional force can be used to simulate surface texture. The next generation of electrotactile devices aims to provide haptic feedback associated with onscreen content. To maximise the haptic resolution of these devices, a dedicated stylus may be provided to enable indirect interaction with the touch input panel.

The apparatus and methods disclosed herein may or may not address this issue.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

According to a first aspect, there is provided an apparatus comprising:
a shaft configured to be gripped by a user during use of the apparatus to provide a touch input to a touch input panel; and
a tip located at an interacting end of the apparatus for interacting with the touch input panel, the tip comprising an electrically conductive element and an electrically insulating material, the electrically insulating material configured to capacitively decouple the electrically conductive element from the shaft and/or user,
wherein the electrically conductive element is configured to couple capacitively to an electrotactile electrode of the touch input panel when the electrically conductive element is in proximity to the electrotactile electrode, capacitive coupling between the electrically conductive element and the electrotactile electrode configured to create vibrations in the tip of the apparatus to cause a variation in the frictional force between the tip and the touch input panel as perceived by a user gripping the shaft of the apparatus during relative lateral movement of the tip and touch input panel.

Capacitive coupling between the electrically conductive element and the electrotactile electrode may be configured to create vibrations in the touch input panel. The vibrations in the touch input panel may cause a variation in the frictional force between the tip and the touch input panel as perceived by a user gripping the shaft of the apparatus during relative lateral movement of the tip and touch input panel.

Vibration of the tip and/or touch input panel may be dependent upon the amplitude, phase, polarity and/or frequency of periodic potentials applied to the electrically conductive element and/or electrotactile electrode.

The apparatus may comprise a processor and/or memory configured to create vibrations in the tip by controlling the capacitive coupling.

The term “touch input” may be taken to encompass point inputs (e.g. for selecting onscreen content), swipe inputs (e.g. for manipulating onscreen content), and scribe inputs (e.g. for writing or drawing on the touch input panel).

The tip may comprise a mechanically resilient material (which may or may not be the electrically insulating material) configured to provide for vibration of the tip. The tip may comprise a mechanically resilient material (which may or may not be the electrically insulating material) configured such that the contact area between the tip and the touch input panel increases when the tip is pressed against the touch input panel to produce a predefined (e.g. enhanced) frictional force between the tip and touch input panel during relative lateral movement of the tip and touch input panel when in contact. The predefined (e.g. enhanced) frictional force may be configured to vary the amplitude of vibration required for perception of the variation in frictional force by the user. The predefined (e.g. enhanced) frictional force may be configured to reduce the amplitude of vibration required for perception of the variation in frictional force by the user.

The tip may comprise an interacting surface (which may or may not be formed from the electrically insulating material) configured to interact with the touch input panel. The interacting surface may be configured to prevent a flow of electrical current between the electrotactile electrode of the touch input panel and the electrically conductive element of the apparatus (i.e. the interacting surface serves as the dielectric of a dynamic capacitor). The tip may comprise a flat interacting surface (which may or may not be formed from the electrically insulating material) configured to interact with the touch input panel during relative lateral movement of the tip and touch input panel. The electrically conductive element may comprise a planar portion oriented parallel to the flat interacting surface of the tip to provide for capacitive coupling between the electrically conductive element and the electrotactile electrode. The planar portion of the electrically conductive element may be positioned on, or in proximity to, the flat interacting surface of the tip to provide for capacitive coupling between the electrically conductive element and the electrotactile electrode.

The electrically conductive element may comprise a planar portion which extends laterally beyond the shaft to provide for capacitive coupling between the electrically conductive element and the electrotactile electrode. The planar portion of the electrically conductive element may be optically transparent.

The tip (i.e. the electrically conductive material of the tip or another component of the tip) may comprise a predefined roughness configured to produce a predefined (e.g. enhanced) frictional force between the tip and touch input panel during relative lateral movement of the tip and touch input panel when in contact. The predefined (e.g. enhanced) frictional force may be configured to vary the amplitude of vibration required for perception of the variation in frictional force by the user. The predefined (e.g. enhanced) frictional force may be configured to reduce the amplitude of vibration required for perception of the variation in frictional force by the user.

The tip may comprise a material (which may or may not be the electrically insulating material) configured to produce a predefined coefficient of friction between the tip and the touch input panel during relative lateral movement of the tip and touch input panel when in contact. The predefined coefficient of friction may be configured to vary the amplitude of vibration required for perception of the variation in frictional force by the user. The predefined coefficient of friction may be configured to reduce the amplitude of vibration required for perception of the variation in frictional force by the user.

The tip may comprise a protective coating (e.g. on top of the electrically conductive material or another component of the tip) configured to reduce degradation of the tip during relative lateral movement of the tip and touch input panel when in contact.

The apparatus may comprise a wire extending from the electrically conductive element to a terminal of an electrotactile module to enable a potential to be applied to the electrically conductive element via the wire.

The apparatus may comprise an electrically conductive material and a wire extending between the electrically conductive material and the electrically conductive element to enable a potential to be applied to the electrically conductive element via the electrically conductive material and the wire. The electrically conductive material may be an electrical contact configured for direct electrical connection to a terminal of an electrotactile module.

The electrically conductive material may form part of the apparatus shaft and may be configured for electrical connection to a terminal of an electrotactile module via the user during gripping of the shaft. The shaft of the apparatus may comprise one or more electrically conductive traces located on an external surface of the shaft. The one or more electrically conductive traces may be configured to ensure electrical contact between the user and the electrically conductive material.

According to a further aspect, there is provided a system comprising the apparatus described herein and the touch input panel.

The touch input panel may comprise one or more (input) sensor electrodes. The one or more sensor electrodes may be configured to couple capacitively to the electrically conductive element of the apparatus when the electrically conductive element is in proximity to the sensor electrode. Capacitive coupling between the one or more sensor electrodes and the electrically conductive element may be configured to generate a touch input signal to enable detection of a touch input.

Physical contact is not necessarily required between the tip and touch input panel to generate the touch input signal provided that the electrically conductive element is able to couple sufficiently to the one or more sensor electrodes.

The touch input panel may comprise a single electrotactile electrode in the form of an electrotactile layer. The electrotactile layer may comprise apertures configured to reduce capacitive cross-coupling between the one or more sensor electrodes and the electrotactile layer. The one or more sensor electrodes may serve as separate electrotactile electrodes.

The touch input panel may comprise a layer of electrically insulating material configured to prevent a flow of electrical current between the electrotactile electrode of the touch input panel and the electrically conductive element of the apparatus.

The system may comprise an electronic display configured to show the position of a touch input provided by the apparatus to the touch input panel. The electronic display may form part of the touch input panel. The electronic display may be separate from the touch input panel.

The system may comprise an electrotactile module configured to apply a potential to the electrotactile electrode of the touch input panel to provide for capacitive coupling between the electrically conductive element and the electrotactile electrode. The electrotactile module may form part of the touch input panel. The electrotactile module may form part of the apparatus. The electrotactile module may be configured to apply a potential to the electrically conductive element of the apparatus to provide for capacitive coupling between the electrically conductive element and the electrotactile electrode. The applied potentials may be configured to cause periodic attraction and/or periodic repulsion of the electrically conductive element and the electrotactile electrode. A terminal of the electrotactile module may be configured for electrical connection to the apparatus and/or user.

The apparatus may be one or more of a touch input stylus and a module for a touch input stylus. The touch input panel may be one or more of an electronic device, a portable electronic device, a portable telecommunications device, a touchscreen for any of the aforementioned devices and a module for any of the aforementioned devices.

According to a further aspect, there is provided an apparatus comprising:
a shaft configured to be gripped by a user during use of the apparatus to provide a touch input to a touch input panel; and
a tip located at an interacting end of the apparatus for interacting with the touch input panel, the tip comprising an electrically conductive element and an electrically insulating material,
wherein the electrically conductive element is configured to couple capacitively to an electrotactile electrode of the touch input panel when the electrically conductive element is in proximity to the electrotactile electrode, and
wherein the electrically insulating material is configured to separate the electrically conductive element from the shaft to capacitively decouple the shaft and/or user from the electrotactile electrode such that capacitive coupling between the electrically conductive element and the electrotactile electrode is able to create vibrations in the tip of the apparatus to cause a variation in the frictional force between the tip and the touch input panel as perceived by the user gripping the shaft of the apparatus during relative lateral movement of the tip and touch input panel.

According to a further aspect, there is provided a method of varying the frictional force between a tip of an apparatus and a touch input panel, the apparatus comprising:
a shaft configured to be gripped by a user during use of the apparatus to provide a touch input to a touch input panel; and
a tip located at an interacting end of the apparatus for interacting with the touch input panel, the tip comprising an electrically conductive element and an electrically insulating material, the electrically insulating material configured to capacitively decouple the electrically conductive element from the shaft and/or user,
wherein the electrically conductive element is configured to couple capacitively to an electrotactile electrode of the touch input panel when the electrically conductive element is in proximity to the electrotactile electrode, capacitive coupling between the electrically conductive element and the electrotactile electrode configured to create vibrations in the tip of the apparatus to cause a variation in the frictional force between the tip and the touch input panel as perceived by a user gripping the shaft of the apparatus during relative lateral movement of the tip and touch input panel, the method comprising:
creating vibrations in the tip of the apparatus using capacitive coupling between the electrically conductive element and the electrotactile electrode, the vibrations created in the tip causing a variation in the frictional force between the tip and the touch input panel as perceived by a user gripping the shaft of the apparatus during relative lateral movement of the tip and touch input panel.

The steps of any method disclosed herein do not have to be performed in the exact order disclosed, unless explicitly stated or understood by the skilled person.

Corresponding computer programs (which may or may not be recorded on a carrier) for implementing one or more of the methods disclosed are also within the present disclosure and encompassed by one or more of the described example embodiments.

The present disclosure includes one or more corresponding aspects, example embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:—

FIG. 1a shows a stylus being used to provide a point input;

FIG. 1b shows a stylus being used to provide a swipe input;

FIG. 1c shows a stylus being used to provide a scribe input;

FIG. 2 shows an apparatus configured to provide electrotactile feedback;

FIG. 3 shows a stylus according to one embodiment of the present disclosure;

FIG. 4a shows the use of a stylus for selecting on-screen content;

FIG. 4b shows the use of a stylus for scribing on the surface of a device;

FIG. 5a shows a periodic electrotactile signal which can be applied either to a device to induce periodic attraction, or to a device and stylus to induce periodic repulsion;

FIG. 5b shows periodic electrotactile signals which can be applied to a device and stylus to induce periodic attraction;

FIG. 5c shows constant and periodic electrotactile signals which can be applied to a device and stylus to induce periodic attraction and repulsion;

FIG. 6 shows the direct application of an electrotactile signal to a stylus;

FIG. 7 shows the application of an electrotactile signal to a stylus via a user's body;

FIG. 8 shows graphically how friction induced by electrotactile and non-electrotactile methods can be used in combination to reduce the amplitude of voltage required for texture detection;

FIG. 9a shows how the shape of a stylus tip can be used to control the frictional force between the stylus and a device;

FIG. 9b shows how the roughness of a stylus tip can be used to control the frictional force between the stylus and a device;

FIG. 9c shows how the size of the electrically conductive element can be used to control the frictional force;

FIG. 10 shows an electrotactile layer comprising apertures configured to reduce capacitive cross-coupling;

FIG. 11 shows how the same electrode can be used to detect touch inputs and provide haptic feedback at different times;

FIG. 12 shows how a comparator circuit can be used to enable the same electrode to detect touch inputs and provide haptic feedback simultaneously;

FIG. 13 shows one embodiment of the apparatus described herein as part of a system;

FIG. 14 shows an electronic display being used to track the movement of a stylus;

FIG. 15 shows a stylus interacting directly and indirectly with on-screen content;

FIG. 16 shows a method of using the apparatus described herein; and

FIG. 17 shows a computer readable medium comprising a computer program for controlling use of the apparatus described herein.

### DESCRIPTION OF SPECIFIC ASPECTS/EMBODIMENTS

Touchscreen interfaces are electronic visual displays which can detect the presence and location of a touch input within the display/interface area. The term “touchscreen” generally refers to interfaces which interact with a user's finger, but most technologies can also sense other passive objects, such as a stylus.

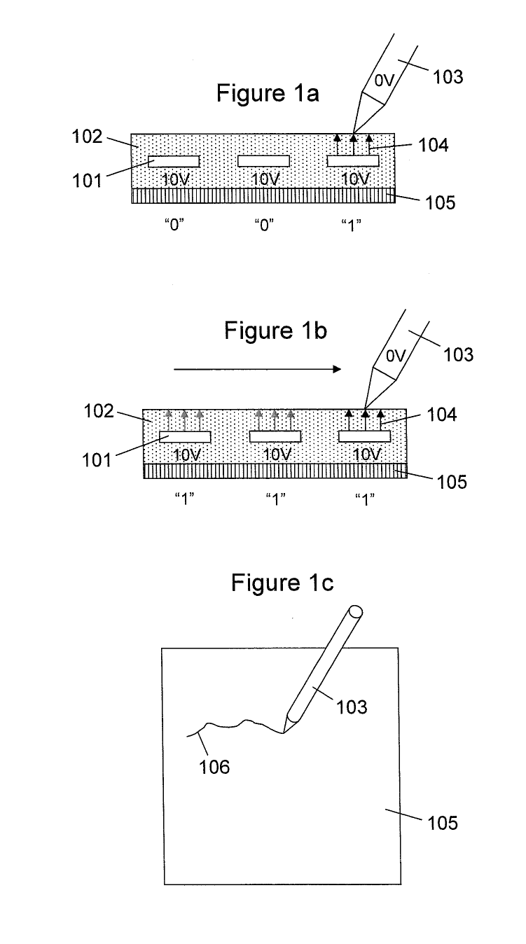

A variety of different touchscreen technologies currently exist. One of these is capacitive touchscreens (as illustrated in FIG. 1) which comprise capacitive touch sensors 101 positioned adjacent to an electronic display 105 to allow the user to interact with onscreen content. A capacitive touch sensor comprises an electrical conductor 101 (electrode) separated from the external environment by an electrical insulator 102. An electrostatic potential (10V in the examples illustrated) is applied to charge the electrode 101. When the user's finger or a stylus 103 (which will often be grounded) is brought into proximity of the charged electrode 101 (e.g. by touching the electrical insulator 102), opposite charges are induced on the finger/stylus 103 and an electric field 104 is formed therebetween (i.e. the electrode 101 couples capacitively to the finger/stylus 103). The electrode 101 and the finger/stylus 103 effectively serve as the opposite plates of a (dynamic) capacitor. Therefore, when the finger/stylus 103 approaches the sensor, the total capacitance associated with the electrode 101 increases (typically by 1fF-5 pF). This change in capacitance is then detected, and if the change exceeds a predetermined threshold value, the sensor interprets this as a touch input. As shown in FIG. 1a, the sensor changes from a “0” state (no touch input) to a “1” state (touch input detected).

Touchscreen displays typically comprise a two-dimensional array (matrix) of capacitive touch sensors. This arrangement allows the user to interact directly with content displayed at different regions of the display. By using an array of capacitive touch sensors, it is also possible to pin-point the position of touch by averaging the signals from multiple sensors. This is useful when the touch input lies between adjacent sensors or spans multiple sensors. Nevertheless, touch input detection tends to be more accurate when the position of touch coincides with the position of a sensor, so a greater density of sensors is usually advantageous.

FIG. 1b shows how the sensor array can be used to detect a swipe input. As the name suggests, a swipe input involves the user sliding his or her finger/stylus 103 across the surface of the touchscreen. As the user's finger/stylus 103 moves across the surface, any sensors 101 which come into proximity of the finger/stylus 103 (e.g. directly under the finger/stylus 103) are progressively activated. This is illustrated by the electric field lines 104 at the respective sensors 101 and the corresponding “1” states.

An array of capacitive touch sensors also enables a user to scribe on the touchscreen using her or her finger/stylus 103 (i.e. providing a scribe input), as shown in FIG. 1c. As the user's finger/stylus 103 moves across the surface, any sensors 101 which come into proximity of the finger/stylus 103 (e.g. directly under the finger/stylus 103) are progressively activated, as described with reference to FIG. 1b. The touch input signals generated by the scribe input are detected by a system processor which then controls the pixels of the electronic display 105 to track 106 the movement of the stylus 103. This technique can therefore be used for writing or drawing directly onto the touchscreen, e.g. for acknowledging postal deliveries using a PDA.

In contrast to scribing on paper using a pen or pencil, the use of a stylus for scribing on a touchscreen is currently unsatisfactory due to the lack of haptic feedback associated with the smooth surface. Not only does the smooth surface feel unfamiliar to the user, but the lack of friction also makes it difficult to control the movement of the stylus during the scribing operation. Electrotactile systems have recently been proposed for generating haptic feedback, which may help to address this problem. This technology is based on either electrovibration or electrostatic tactile actuation.

With electrovibration, vibrations are generated in the skin when a fingertip is swiped across an insulating layer above an electrical conductor carrying an alternating potential. The effect is a result of the varying electrostatic attraction between the conductor and the deeper, liquid-rich conducting layers of the skin. These vibrations can be used to trick mechanoreceptors in the skin into perceiving virtual texture. Although the vibrations are typically too weak to be perceived when the finger is static, they vary the frictional force between the skin of a moving finger and the underlying surface to provide a rubbery sensation which is readily detectable. With electrostatic tactile actuation, on the other hand, the user swipes a stylus (or other conductive object) across the insulating layer, and the alternating potential generates vibrations in the stylus which are transferred to the user's finger. In this case, therefore, the tactile sensation is created indirectly.

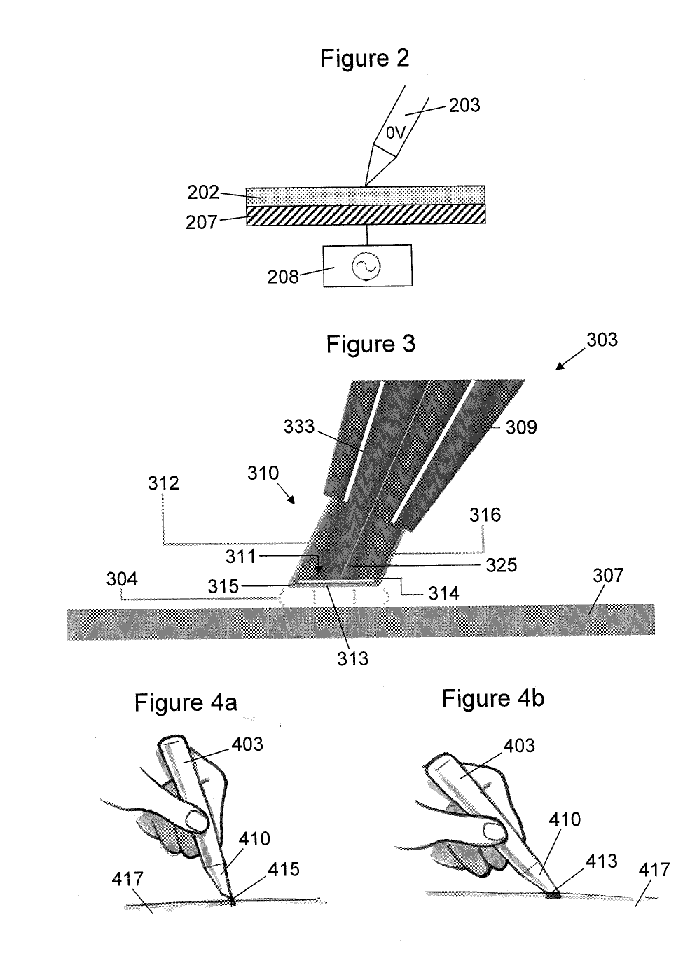

FIG. 2 shows an example of an electrotactile system. The electrotactile system comprises an electrically conductive layer 207 (referred to herein as the electrotactile layer), an electrically insulating layer 202 and a power supply 208, the electrically insulating layer 202 positioned between the user's finger/stylus 203 and the electrotactile layer 207. The power supply 208 is configured to charge the electrotactile layer 207, and the electrically insulating layer 202 is configured to prevent a flow of current between the electrotactile layer 207 and the finger/stylus 203 when the finger/stylus 203 is proximate to the electrotactile layer 207.

When the power supply 208 charges the electrotactile layer 207, the surface charge induces charges of opposite polarity on the finger/stylus 203 thereby forming an electric field between the finger/stylus 203 and the electrotactile layer 207. This may be visualised as a (dynamic) capacitor, where the electrotactile layer 207 is the first electrode and the finger/stylus 203 is the second electrode, the first and second electrodes separated by an electrical insulator 202. The electrostatic force generated by the charge on the electrotactile layer 207 attracts the charge on the finger/stylus 203 causing movement of the finger/stylus 203.

To generate vibration in the finger/stylus, the power supply 208 varies the magnitude (and/or polarity) of charge on the electrotactile layer 207 periodically. The variation of charge causes variations in electric field strength (and/or direction) which in turn causes vibrations in the finger/stylus 203. By controlling the electric field strength, it is possible to tune the amplitude and frequency of the vibrations to a specific mechanoreceptor in the skin. Unlike some other types of haptic feedback technology, physical contact between the finger/stylus 203 and the device is not required because the electrotactile layer 207 couples capacitively to the finger/stylus 203 via the electric field (i.e. action at a distance).

Electrotactile systems may be used to vary the frictional force between the user's finger/stylus and the touchscreen surface to produce virtual textures which are perceivable by the user during a scribing operation. This could potentially be used to simulate the physical interaction between different writing/drawing stationery and a range of different surfaces (e.g. a pencil on paper, charcoal on canvas or a marker pen on glass).

The change in frictional force, ΔF, can be quantified using the following equation:

$$Δ F = \frac{\partial E}{\partial d} \qquad Equation 1$$

where E is the electrostatic energy and d is the distance between the finger/stylus and the electrotactile layer. The electrostatic energy is given by:

$$E = \frac{{ɛ}_{0} {ɛ}_{r} {AV}^{2}}{2} \qquad Equation 2$$

where ∈₀ is the permittivity of free space, ∈ᵣ is the relative permittivity of the medium separating the finger/stylus from the electrotactile layer, A is the area of the finger/stylus in contact with the touchscreen surface, and V is the potential applied to the electrotactile layer. Substituting the electrostatic energy in Equation 1 and differentiating gives:

$$Δ F = 8.85 \times {10}^{- 12} {A ( \frac{V}{d} )}^{2} \qquad Equation 3$$

Current stylus designs typically provide a contact area of ˜1 mm². When a peak potential of 100V is applied to the electrotactile layer and the spacing between the electrotactile layer and the stylus is 1 μm, Equation 3 gives a variation in frictional force of less than 0.1N. This magnitude of change is difficult for the human sensory system to detect. There will now be described an apparatus and associated method which may provide a solution to this problem.

In the following description, the apparatus of the present disclosure is referred to as a “stylus”. It will be appreciated, however, that the apparatus could also be a module for a stylus rather than the stylus per se. Furthermore, although the foregoing discussion is in relation to touchscreens, it will be appreciated that a touch user interface does not necessarily require a visual display in order to detect a touch input.

FIG. 3 shows a touch input stylus comprising a shaft 309 configured to be gripped by a user during use of the stylus to provide a touch input to a touch input panel (although only the bottom end of the shaft 309 is shown in this figure), and a tip 310 located at an interacting end of the stylus for interacting with the touch input panel. The tip 310 of the stylus comprises an electrically conductive element 311 and an electrically insulating material 312, the electrically insulating material 312 configured to capacitively decouple the electrically conductive element 311 from the shaft 309 and/or user.

The electrically conductive element 311 is configured to couple capacitively to an electrotactile electrode 307 of the touch input panel when the electrically conductive element 311 is in proximity to the electrotactile electrode 307. Capacitive coupling between the electrically conductive element 311 and the electrotactile electrode 307 creates vibrations in the tip 310 of the stylus causing a variation in the frictional force between the tip 310 and the touch input panel as perceived by a user gripping the shaft 309 during relative lateral movement of the tip 310 and touch input panel.

By capacitively decoupling the electrically conductive element 311 from the shaft 309 (which is particularly useful when the shaft 309 is made from or comprises an electrically conductive material) and/or the user, the electrically conductive element 311 is able to couple to the electrotactile electrode 307 almost independently of the shaft 309 and/or user. As a result, the tip 310 of the stylus (comprising the electrically conductive element 311) is able to vibrate independently. This independent vibration enables a detectable variation in friction to be created.

One or more additional features may be implemented to maximise vibration of the tip 310 and produce a greater change in the frictional force. For example, the electrically insulating material 312 may be made from a mechanically resilient material such as an elastomeric polymer (e.g. rubber). Additionally or alternatively, the electrically conductive element 311 may be positioned as close to the touch input panel as possible to increase the capacitance between the electrically conductive element 311 and the electrotactile electrode 307. For example, in FIG. 3, the tip 310 comprises a flat interacting surface 313 configured to interact with the touch input panel during relative lateral movement of the tip 310 and touch input panel, and the electrically conductive element 311 comprises a planar portion 314 oriented parallel to the flat interacting surface 313 of the tip 310. The planar portion 314 of the electrically conductive element 311 may be positioned on, or in proximity to, the flat interacting surface 313 of the tip 310.

An advantage of the flat interacting surface 313, 413 of the tip 310, 410 is that it facilitates the application of point, swipe and scribe inputs using the stylus 303, 403. As shown in FIG. 4a, the edge 415 of the flat interacting surface 413 can be used to provide a point input if the user needs to interact with the touch input panel 417 with greater precision (e.g. to select a small icon). When the user wishes to provide a scribe input, on the other hand, he can simply adjust his grip of the stylus 403 so that the flat interacting surface 413 is parallel to the underlying surface during relative lateral movement of the tip 410 and touch input panel 417 (FIG. 4b). In this orientation, the greater degree of capacitive coupling allows the user to perceive the simulated texture. When the user wishes to provide a swipe input, either the precision grip (FIG. 4a) or the friction grip (FIG. 4b) may be adopted.

It is important that there is no electrical contact between the electrically conductive element 311 and the electrotactile electode 307 otherwise an electrical current would flow between the electrically conductive element 311 and the electrotactile electrode 307 and there would be no capactive coupling therebetween. If the touch input panel comprises a layer of electrically insulating material above the electrotactile electrode 307, then the planar portion 314 of the electrically conductive element 311 may be positioned on the interacting surface 313 of the tip 310. If the touch input panel does not comprise such a layer, however, then the planar portion 314 of the electrically conductive element 311 should be separated from the interacting surface 313 of the tip 310 by a layer of electrically insulating material 316 (as shown in FIG. 3). This layer of electrically insulating material 316 could be part of the electrically insulating material 312 or an additional layer. Suitable materials include high dielectric constant (as compared to silicon dioxide) materials such as hafnium and aluminium oxides. In the form of tin (Sn) films, these materials also exhibit optical transparency.

Another option for facilitating vibration of the tip 310 is to increase the surface area of the electrically conductive element 311. FIG. 9c shows an embodiment in which the electrically conductive element 911 comprises a planar portion 914 which extends laterally beyond the shaft 909 of the stylus. The increase in surface area increases the capacitance between the electrically conductive element 911 and the electrotactile layer resulting in greater coupling and a stronger vibration. In this example, the electrically conductive element 911 may be made from an optically transparent material (such as graphene or indium tin oxide) so as not to obscure the user's view of the tip 910 during the scribing operation.

Whilst the stylus would typically be in physical contact with the touch input panel when scribing, this is not necessarily required. Depending on the strength of capacitive coupling between the electrically conductive element 311 of the stylus and the electrotactile electrode 307 of the touch input panel (which is dependent upon the surface area, spacing and electrostatic potential of the electrically conductive element 311 and electrotactile electrode 307), it may be possible for the capacitive touch sensors of the touch input panel to detect a touch input when the stylus tip 310 is hovering over the touch input panel. Nevertheless, the tip 310 may comprise a protective coating 316 (e.g. a diamond-like coating) configured to reduce degradation of the tip 310 during relative lateral movement of the tip 310 and touch input panel when in contact, as shown in FIG. 3. Such a coating 316 may also serve to reduce the frictional force between the tip 310 and touch input panel to within an acceptable level for scribing when the coefficient of friction is too great.

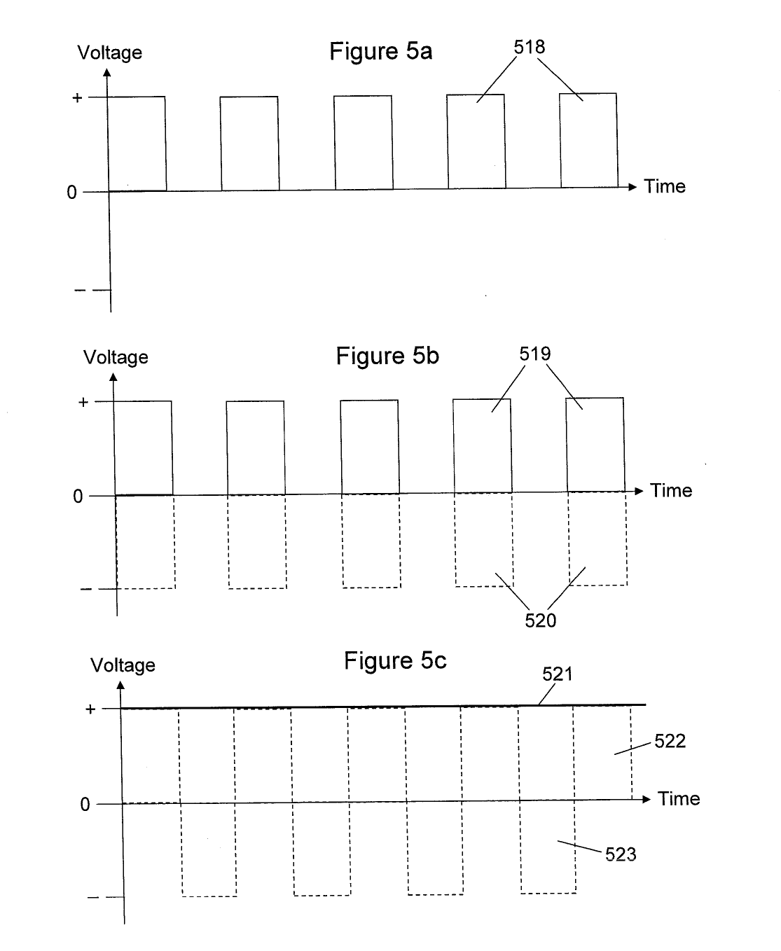

In order to cause the electrically conductive element 311 of the stylus to couple capacitively to the electrotactile electrode 307 of the touch input panel, a periodic potential (e.g. with an amplitude of 10-250V) is applied to the electrotactile electrode 311 and/or the electrically conductive element 307. This may be performed by an electrotactile module located in the touch input panel and/or stylus. When the periodic potential is applied to the electrotactile electrode 307 only, the signal may comprise a series of positive 518 (as shown in FIG. 5a) or negative voltage pulses. In this scenario, the positive or negative voltage pulses 518 induce charges of opposite polarity on the electrically conductive element 311 causing periodic attraction between the electrically conductive element 311 and the electrotactile electrode 307 (i.e. the stylus is operated in passive mode).

When the potential is applied only to the electrotactile electrode 307, the vibrations in the tip 310 may be relatively weak. This could make it difficult to increase the frictional force sufficiently to simulate rougher textures. An alternative option is to apply a potential to both the electrotactile electrode 307 and the electrically conductive element 311 (i.e. the stylus is operated in active mode). For example, the same positive or negative voltage pulses 518 could be applied to the electrotactile electrode 307 and the electrically conductive element 311. In this scenario, the like charges on the surfaces of the electrotactile electrode 307 and electrically conductive element 311 cause periodic repulsion. Alternatively, positive (or negative) voltage pulses 519 could be applied to the electrotactile electrode 307, and voltage pulses of opposite polarity 520 could be applied to the electrically conductive element 311 (as shown in FIG. 5b). In this scenario, the opposite charges on the surfaces of the electrotactile electrode 307 and electrically conductive element 311 cause periodic attraction.

To produce even stronger vibrations in the stylus tip 310, alternating attractive and repulsive forces could be generated between the electrotactile electrode 307 and the electrically conductive element 311. The amplitude of vibration is larger in this scenario because the electrotactile electrode 307 and electrically conductive element 311 are forced together and forced apart alternately rather than being periodically forced together or periodically forced apart. To achieve this, a constant positive or negative potential 521 could be applied to the electrotactile electrode 307 and a periodic potential (which alternates between positive 522 and negative 523 voltage pulses) could be applied to the electrically conductive element 311. These signals are shown in FIG. 5c. Alternatively, the constant potential 521 could be applied to the electrically conductive element 311 and the periodic potential 522, 523 could be applied to the electrotactile electrode 307.

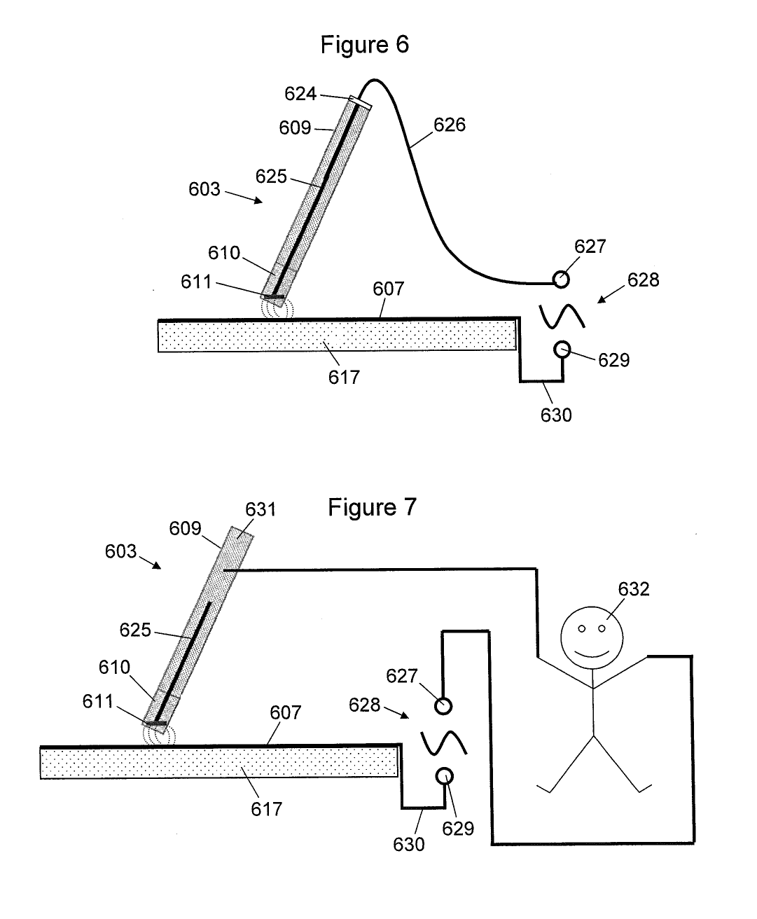

FIGS. 6 and 7 show how the potentials may be applied by the electrotactile module to the electrotactile electrode and electrically conductive element. In these examples, the electrically conductive element is sealed within the electrically insulating material of the stylus tip. In FIG. 6, the stylus 603 comprises an electrical contact 624 and a wire 625 extending between the electrical contact 624 and the electrically conductive element 611 to enable a potential to be applied to the electrically conductive element 611 via the electrical contact 624 and wire 625. In this example, a direct electrical connection 626 is made between the electrical contact 624 and one terminal 627 of the electrotactile module 628. The other terminal 629 of the electrotactile module 628 is connected (by a direct or indirect electrical connection 630) to the electrotactile electrode 607 of the touch input panel 617. The direct electrical connection 626 between the electrical contact 624 and the terminal 627 of the electrotactile module 628 may be an extension of the wire 625 itself, or it could be a separate connection. In the former scenario, the electrical contact 624 is not required.

In FIG. 7, the shaft 609 of the stylus comprises an electrically conductive material 631 and a wire 625 which extends between the electrically conductive material 631 and the electrically conductive element 611 to enable a potential to be applied to the electrically conductive element 611 via the electrically conductive material 631 and wire 625. In this example, the electrically conductive material 631 of the stylus shaft 609 is configured for indirect connection to one terminal 627 of the electrotactile module 628 via the user 632. The other terminal 629 of the electrotactile module 628 is connected (by a direct or indirect electrical connection 630) to the electrotactile electrode 607 of the touch input panel 617. To enable a potential to be applied to the electrically conductive element 611, therefore, the user 632 must be in electrical contact with both the terminal 627 of the electrotactile module 628 and the electrically conductive material 631 of the stylus shaft 609. This may be achieved in practice by holding the touch input panel 617 in one hand (and touching an exposed terminal 627 of the electrotactile module 628 formed thereon) and gripping the stylus shaft 609 in the other hand.

The embodiment shown in FIG. 7 is advantageous in the sense that the user's body replaces the physical connection 626 between the stylus 603 and electrotactile module 628. It is important to mention, however, that although this configuration involves passing an electrical current though the user's body, this current would typically be of the order of microamperes, which is well below the human sensing threshold and therefore will not cause discomfort to the user 632.

The electrically conductive material 631 may be a mechanically resilient material (e.g. an elastomeric polymer such as conductive rubber) to reduce damping of the vibrations in the tip 610 and also to enable the vibrations to be felt by the user 632 during gripping of the shaft 609. The shaft 609 may also comprise one or more electrically conductive traces 333 located on an external surface to ensure electrical contact between the user 632 and the electrically conductive material 631. The electrically conductive traces 333 are shown in FIG. 3.

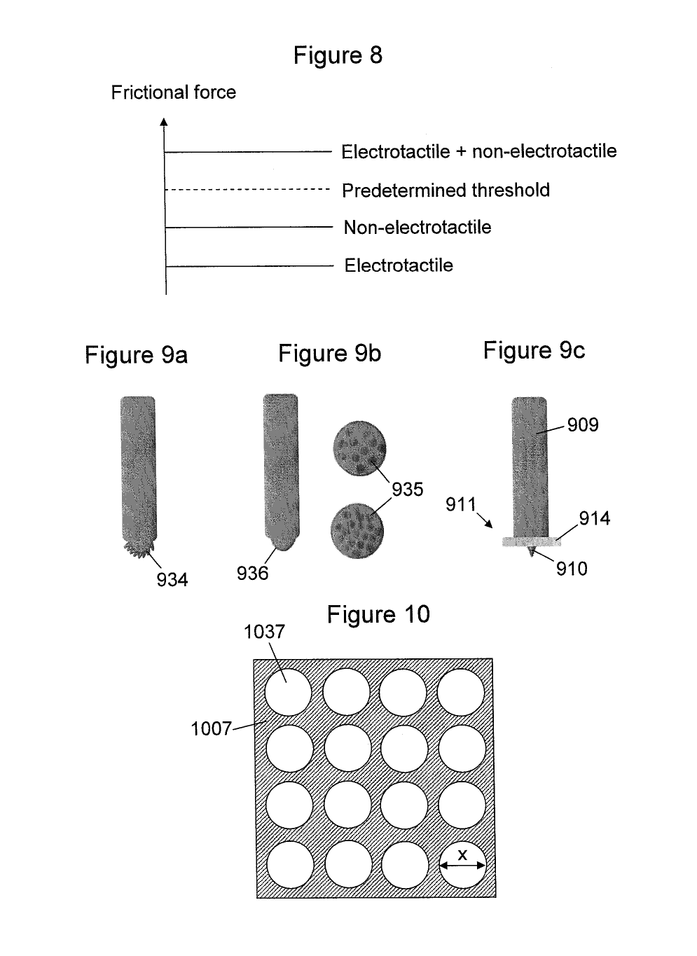

In order for the user to perceive the electrotactile induced friction, the total frictional force (comprising both electrotactile and non-electrotactile components) must be above a predetermined threshold. This concept is illustrated graphically in FIG. 8. Therefore, when the coefficient of friction (which is dependent upon the materials in contact) is relatively low, a higher potential must be applied to the electrotactile electrode and/or electrically conductive element before the total frictional force exceeds this predetermined threshold. In this respect, it may be advantageous to increase the non-electrotactile induced friction to a level which is just below the predetermined threshold. A relatively low potential can then be used to cause a substantial change in the perceived friction.

There are a number of different ways of enhancing the non-electrotactile component of friction. Examples include: increasing the contact area between the tip and the touch input panel; increasing the roughness of the tip; and increasing the coefficient of friction. One technique for increasing the contact area between the tip and the touch input panel is to incorporate a mechanically resilient material (e.g. an elastomeric polymer such as rubber) into the tip such that the contact area increases when the tip is pressed against the touch input panel during relative lateral movement of the tip and touch input panel when in contact. The roughness of the tip may be increased by forming a plurality of protrusions 934 on the interacting surface (FIG. 9a) or by applying a predefined texture 935 to the interacting surface (FIG. 9b). The coefficient of friction may be increased by forming at least the end of the tip from a high coefficient material 936 (such as silicone rubber) or by depositing a high coefficient material 936 on the interacting surface of the tip (FIG. 9b).

The touch input panel comprises one or more sensor electrodes. In this case, each sensor electrode is configured to couple capacitively to the electrically conductive element of the stylus when the electrically conductive element is in proximity to the sensor electrode. Capacitive coupling between the sensor electrode and the electrically conductive element generates a touch input signal which enables detection of a touch input. One issue with placing electrical conductors in proximity to one another is capacitive cross-coupling between the conductors. This can arise when one or more electrotactile electrodes are incorporated into a touch input panel comprising one or more sensor electrodes. Capacitive cross-coupling between the electrotactile electrodes and the sensor electrodes can hinder or prevent the detection of touch inputs by the capacitive touch sensors, it can result in unintentional activation of capacitive touch sensors, and it can increase the amount of charge on the surface of the sensor electrodes to a level which could damage the sensor measurement circuitry.

One way of addressing this issue (as shown in FIG. 10) is to form an electrotactile 1007 layer (rather than discrete electrotactile electrodes) comprising one or more apertures 1037 to reduce the capacitive cross-coupling. The position of the apertures 1037 should coincide substantially with the position of the overlying or underlying (depending on the ordering of the layers in the touch input panel) sensor electrodes. This approach works by increasing the distance between the sensor electrodes and the material forming the electrotactile layer 1007 (e.g. a metal, graphene or indium tin oxide). The size and shape of the apertures 1037 will depend on the size and shape of the sensor electrodes. For example, the apertures may have a circular, square, elliptical, diamond or trapezoidal shape, and may have a maximum in-plane dimension “x” of up to 2, 3, 4 or 5 mm.

Another option for reducing the capacitive cross-coupling between the electrotactile electrodes and the sensor electrodes is to use each of the sensor electrodes as separate electrotactile electrodes (i.e. use the sensor electrodes both for detecting touch inputs and for providing haptic feedback). This approach works by removing the second conductive layer from the touch input panel to eliminate the capacitive cross-coupling altogether, but does require additional circuitry for controlling the state of each electrode.

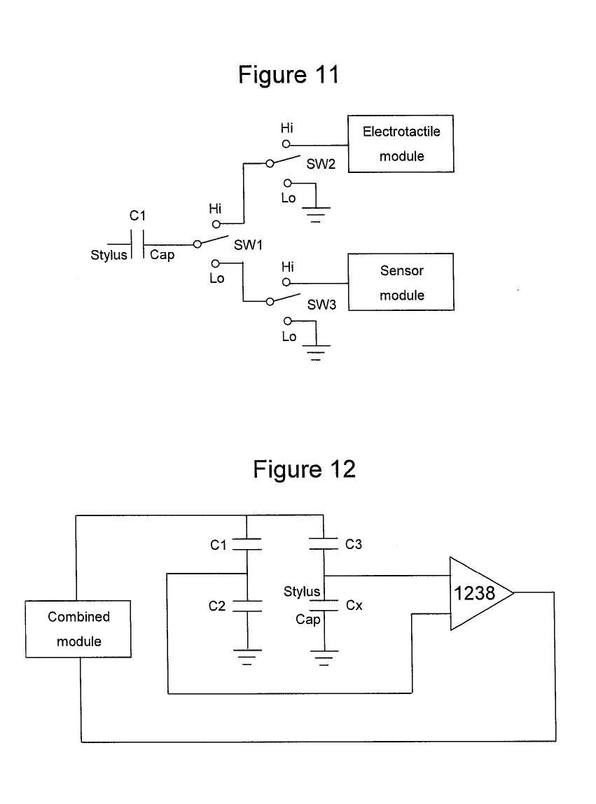

FIG. 11 shows one possible circuit for controlling a sensor electrode so that it can be used for detecting touch inputs and providing haptic feedback alternately. The electrode (Cap) forms a capacitor (C1) with the electrically conductive element of the stylus, and the circuit comprises three switches (SW1-SW3) which are operated simultaneously as follows:

To use the electrode for detecting touch inputs, switches SW1, SW2 and SW3 are set to “low”, “low”, and “high”, respectively (although switch SW2 could be left floating rather than being grounded). In this configuration, the electrode is connected to a sensor module. The sensor module comprises a sensor power supply, a sensor control circuit, and a sensor measurement circuit, and is used to operate the electrode as a sensor. The sensor power supply is configured to apply a potential to the electrode, the sensor control circuit is configured to control the potential applied to the electrode, and the sensor measurement circuit is configured to measure the capacitance, voltage or current associated with the electrode and determine whether or not a touch input has occurred (e.g. by comparing the change in capacitance, voltage or current with a predetermined threshold value).

To use the electrode for providing haptic feedback, on the other hand, switches SW1, SW2 and SW3 are set to “hi”, “hi”, and “low”, respectively (although switch SW3 could be left floating rather than being grounded). In this configuration, the electrode is connected to an electrotactile module. The electrotactile module comprises an electrotactile power supply, an electrotactile control circuit, and a stylus ground, and is used to operate the electrode as an electrotactile element. The electrotactile power supply is configured to apply a potential to the electrode, the electrotactile control circuit is configured to control the potential applied to the electrode (e.g. the amplitude, frequency, duration and/or polarity of the electrotactile signal), and the stylus ground is configured to ground the electrically conductive element when the stylus (being operated in passive mode) is in proximity to the electrode. The stylus ground is not absolutely necessary in passive mode, however, because the user will ground the stylus to some extent anyway (but it might enhance the electrotactile sensation).

It may be necessary (or at least advantageous) to discharge the electrode between states, otherwise residual charge on the electrode from the previous operation might adversely affect the performance of the electrode during the subsequent operation. For example, if the electrode was used to provide haptic feedback then it may comprise a large amount of surface charge as a result of the (relatively large) potential that was applied to the electrode by the electrotactile power supply. If the electrode is then required to function as a capacitive touch sensor, the capacitance of the electrode may exceed the measuring range of the sensor measurement circuit as a result of the surface charge, which could potentially damage the measurement circuit. To discharge the electrode, switches SW1, SW2 and SW3 may each be set to “low”. In this configuration, the electrode is connected to ground.

The circuit diagram of FIG. 11 shows connections to a single sensor. However, the same principles may be applied to an array of sensors. This can be accomplished by multiplexing (not shown) the connection between switch SW1 and the single electrode (Cap).

Rather than applying one signal to the electrode to enable the detection of touch inputs, and a different signal to the electrode to enable the provision of haptic feedback, the same signal may be applied during both operations. One way of achieving this is by using a comparator circuit as shown in FIG. 12. The circuit comprises four capacitors (C1, C2, C3 and Cx) arranged to form a capacitive Wheatstone bridge, a differential amplifier 1238 and a combined module. Capacitor Cx is the dynamic (pseudo) capacitor formed between the electrically conductive element of the stylus and the electrode (Cap) of the touch input panel, whilst capacitors C1, C2 and C3 are standard circuit capacitors. The capacitor values of C1, C2 and C3 are chosen such that there is a negligible potential difference across the inputs of the differential amplifier 1238 when the electrically conductive element is not in proximity to the electrode (i.e. under ambient conditions).

The combined module is used to apply the same alternating signal (periodic potential) to both sides of the Wheatstone bridge. When the electrically conductive element is not in proximity to the electrode, there is no output signal from the differential amplifier 1238. When a touch input is applied to the electrode, however, the change in the capacitance of Cx creates a potential difference across the inputs of the differential amplifier 1238 which is amplified and passed to the combined module. The amplified potential difference therefore serves as the touch input signal. The combined module comprises a rectifier and an analogue-to-digital converter for converting the signal into a digital DC format which is suitable for processing. On detection/receipt of the touch input signal, a processor of the combined module varies the amplitude and/or frequency of the periodic potential to provide a haptic feedback signal which is detectable by the user. Since this signal is applied to both sides of the Wheatstone bridge, it does not affect the detection of further touch inputs. In this way, the comparator circuit is able to detect touch inputs and provide haptic feedback simultaneously.

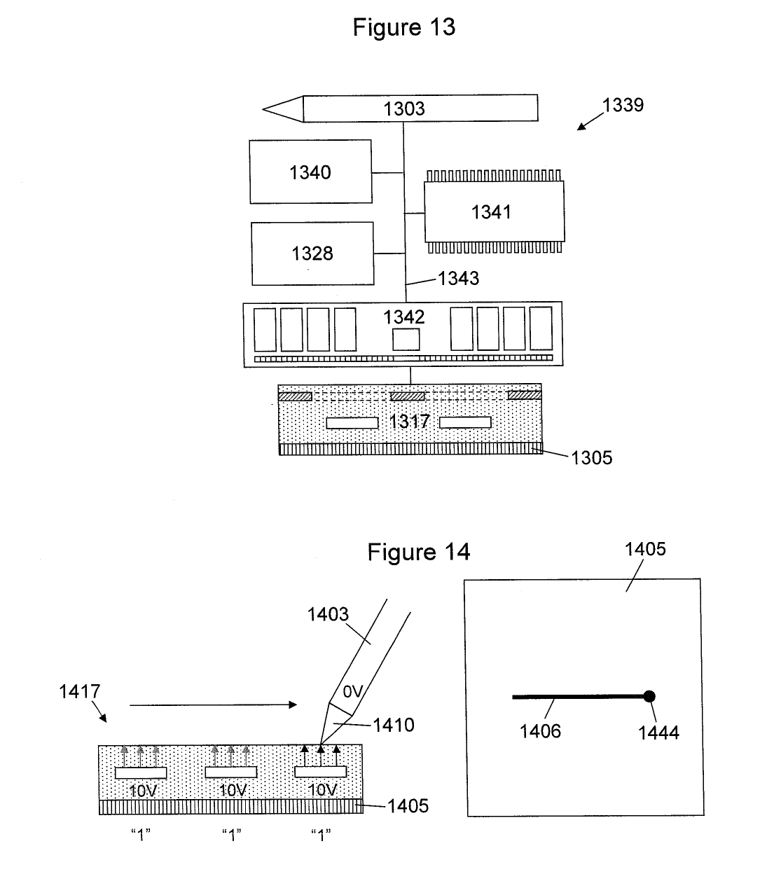

FIG. 13 illustrates schematically a system 1339 comprising the stylus 1303 described herein. The system 1339 also comprises the touch input panel 1317, sensor module 1340, and electrotactile module 1328 described previously, as well as a processor 1341 and a storage medium 1342, all of which are electrically connected to one another by a data bus 1343.

In some embodiments (such as that shown in FIG. 12), the sensor module 1340 and electrotactile module 1328 may be combined to form a single combined module. In addition, the sensor module 1340, electrotactile module 1328, processor 1341 and storage medium 1342 may form part of the stylus 1303, part of the touch input panel 1317 or part of both.

The touch input panel 1317 may be an electronic device, a portable electronic device, a portable telecommunications device, a touchscreen for any of the aforementioned devices, or a module for any of the aforementioned devices.

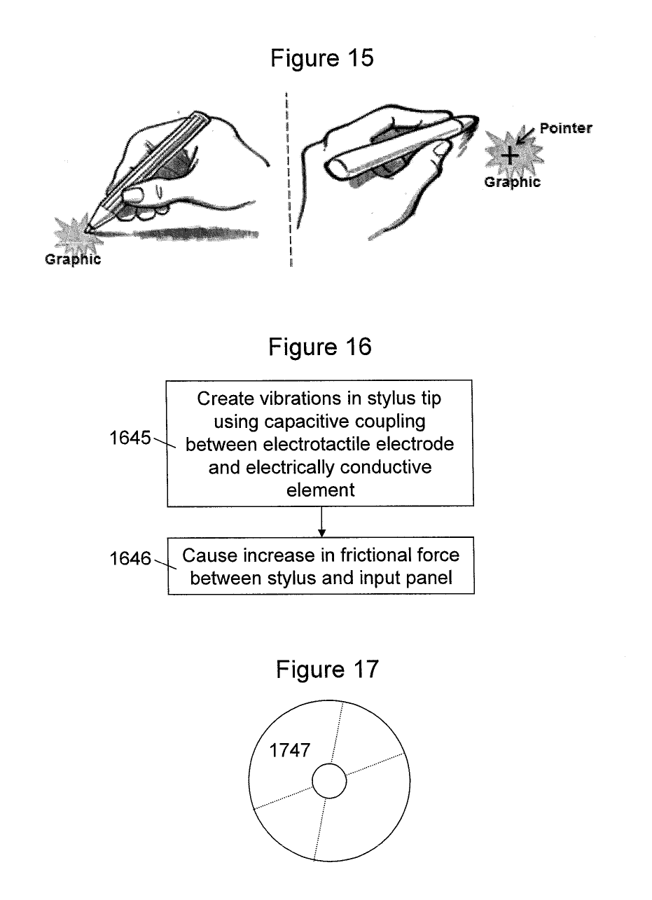

In the example shown, the touch input panel 1317 also comprises an electronic display 1305. As shown in FIG. 14, the electronic display 1405 is configured to trace 1406 the position 1444 of a touch input provided by the stylus 1403 to the touch input panel 1417. The electronic display 1405 may, however, be separate from the touch input panel 1417. In the latter scenario, the electronic display 1405 may be configured to show a pointer to indicate the current position 1444 of the stylus tip 1410. The use of a pointer may nevertheless be beneficial even when the electronic display forms part of the touch input panel (as shown in the left hand part of FIG. 15). For example, the position of the pointer could be displaced from the position of the stylus tip to prevent the stylus from obstructing the user's view of the touch input panel during the provision of a touch input (as shown in the right hand part of FIG. 15).

The processor 1341 is configured for general operation of the system 1339 by providing signalling to, and receiving signalling from, the other components to manage their operation. The storage medium 1342 is configured to store computer code configured to perform, control or enable operation of the system 1339. The storage medium 1342 may also be configured to store settings for the other components. The processor 1341 may access the storage medium 1342 to retrieve the component settings in order to manage the operation of the other components.

In particular, the storage medium 1342 may be configured to store the operation voltages of the sensor electrodes for detecting touch inputs, and the operation voltages of the electrotactile electrodes and the electrically conductive element for providing haptic feedback. The storage medium may also be configured to store predetermined capacitance/voltage/current thresholds for use in determining whether or not a touch input has been applied. The sensor 1340 and electrotactile 1328 modules may access the storage medium 1342 to retrieve the operation voltages. The sensor module 1340 may also compare the present capacitance/voltage/current of each sensor with the predetermined threshold to determine if a touch input has occurred.

The storage medium 1342 may be a temporary storage medium such as a volatile random access memory. On the other hand, the storage medium 1342 may be a permanent storage medium such as a hard disk drive, a flash memory, or a non-volatile random access memory.

The main steps 1645-1646 of a method of using the stylus 1303 are illustrated schematically in FIG. 16.

FIG. 17 illustrates schematically a computer/processor readable medium 1747 providing a computer program according to one embodiment. In this example, the computer/processor readable medium 1747 is a disc such as a digital versatile disc (DVD) or a compact disc (CD). In other embodiments, the computer/processor readable medium 1747 may be any medium that has been programmed in such a way as to carry out an inventive function. The computer/processor readable medium 1747 may be a removable memory device such as a memory stick or memory card (SD, mini SD or micro SD).

The computer program may comprise computer code configured to control the use of an apparatus, the apparatus comprising:
a shaft configured to be gripped by a user during use of the apparatus to provide a touch input to a touch input panel; and
a tip located at an interacting end of the apparatus for interacting with the touch input panel, the tip comprising an electrically conductive element and an electrically insulating material, the electrically insulating material configured to capacitively decouple the electrically conductive element from the shaft and/or user,
wherein the electrically conductive element is configured to couple capacitively to an electrotactile electrode of the touch input panel when the electrically conductive element is in proximity to the electrotactile electrode, capacitive coupling between the electrically conductive element and the electrotactile electrode configured to create vibrations in the tip of the apparatus to cause a variation in the frictional force between the tip and the touch input panel as perceived by a user gripping the shaft of the apparatus during relative lateral movement of the tip and touch input panel, the computer code configured to:
create vibrations in the tip of the apparatus by controlling capacitive coupling between the electrically conductive element and the electrotactile electrode, the vibrations created in the tip causing a variation in the frictional force between the tip and the touch input panel as perceived by a user gripping the shaft of the apparatus during relative lateral movement of the tip and touch input panel.

Other embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

It will be appreciated to the skilled reader that any mentioned apparatus/device and/or other features of particular mentioned apparatus/device may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to different embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
a shaft configured to be gripped by a user during use of the apparatus to provide a touch input to a touch input panel; and
a tip located at an interacting end of the apparatus for interacting with the touch input panel, the tip comprising an electrically conductive element and an electrically insulating material, the electrically insulating material configured to capacitively decouple the electrically conductive element from the shaft and/or user,
wherein the electrically conductive element is configured to couple capacitively to an electrotactile electrode of the touch input panel when the electrically conductive element is in proximity to the electrotactile electrode, capacitive coupling between the electrically conductive element and the electrotactile electrode configured to create vibrations in the tip of the apparatus to cause a variation in the frictional force between the tip and the touch input panel as perceived by a user gripping the shaft of the apparatus during relative lateral movement of the tip and touch input panel.

2. The apparatus of claim 1, wherein the tip comprises a mechanically resilient material configured such that the contact area between the tip and the touch input panel increases when the tip is pressed against the touch input panel to produce a predefined frictional force between the tip and touch input panel during relative lateral movement of the tip and touch input panel when in contact, the predefined frictional force configured to reduce the amplitude of vibration required for perception of the variation in frictional force by the user.

3. The apparatus of claim 1, wherein the tip comprises a flat interacting surface configured to interact with the touch input panel during relative lateral movement of the tip and touch input panel, and wherein the electrically conductive element comprises a planar portion oriented parallel to the flat interacting surface of the tip to provide for capacitive coupling between the electrically conductive element and the electrotactile electode.

4. The apparatus of claim 3, wherein the planar portion of the electrically conductive element is positioned on, or in proximity to, the flat interacting surface of the tip to provide for capacitive coupling between the electrically conductive element and the electrotactile electode.

5. The apparatus of claim 1, wherein the electrically conductive element comprises a planar portion which extends laterally beyond the shaft to provide for capacitive coupling between the electrically conductive element and the electrotactile electode.

6. The apparatus of claim 1, wherein the tip comprises a predefined roughness configured to produce a predefined frictional force between the tip and touch input panel during relative lateral movement of the tip and touch input panel when in contact, the predefined frictional force configured to reduce the amplitude of vibration required for perception of the variation in frictional force by the user.

7. The apparatus of claim 1, wherein the tip comprises a material configured to produce a predefined coefficient of friction between the tip and the touch input panel during relative lateral movement of the tip and touch input panel when in contact, the predefined coefficient of friction configured to reduce the amplitude of vibration required for perception of the variation in frictional force by the user.

8. The apparatus of claim 1, wherein the apparatus comprises a wire extending from the electrically conductive element to a terminal of an electrotactile module to enable a potential to be applied to the electrically conductive element via the wire.

9. The apparatus of claim 1, wherein the apparatus comprises an electrically conductive material and a wire extending between the electrically conductive material and the electrically conductive element to enable a potential to be applied to the electrically conductive element via the electrically conductive material and the wire.

10. The apparatus of claim 9, wherein the electrically conductive material is an electrical contact configured for direct electrical connection to a terminal of an electrotactile module.

11. The apparatus of claim 9, wherein the electrically conductive material forms part of the apparatus shaft and is configured for electrical connection to a terminal of an electrotactile module via the user during gripping of the shaft.

12. A system comprising the apparatus of claim 1 and the touch input panel.

13. The system of claim 12, wherein the touch input panel comprises one or more sensor electrodes, the one or more sensor electrodes configured to couple capacitively to the electrically conductive element of the apparatus when the electrically conductive element is in proximity to the one or more sensor electrodes, capacitive coupling between the one or more sensor electrodes and the electrically conductive element configured to generate a touch input signal to enable detection of a touch input.

14. The system of claim 13, wherein the touch input panel comprises a single electrotactile electrode in the form of an electrotactile layer, and wherein the electrotactile layer comprises apertures configured to reduce capacitive cross-coupling between the one or more sensor electrodes and the electrotactile layer.

15. The system of claim 13, wherein the one or more sensor electrodes serve as separate electrotactile electrodes.

16. The system of claim 12, wherein the system comprises an electrotactile module configured to apply a potential to the electrotactile electrode of the touch input panel to provide for capacitive coupling between the electrically conductive element and the electrotactile electrode.

17. The system of claim 16, wherein the electrotactile module is configured to apply a potential to the electrically conductive element of the apparatus to provide for capacitive coupling between the electrically conductive element and the electrotactile electrode.

18. The system of claim 12, wherein the apparatus is one or more of a touch input stylus and a module for a touch input stylus, and the touch input panel is one or more of an electronic device, a portable electronic device, a portable telecommunications device, a touchscreen for any of the aforementioned devices and a module for any of the aforementioned devices.

19. A method of varying the frictional force between a tip of an apparatus and a touch input panel, the apparatus comprising:
a shaft configured to be gripped by a user during use of the apparatus to provide a touch input to a touch input panel; and
a tip located at an interacting end of the apparatus for interacting with the touch input panel, the tip comprising an electrically conductive element and an electrically insulating material, the electrically insulating material configured to capacitively decouple the electrically conductive element from the shaft and/or user,
wherein the electrically conductive element is configured to couple capacitively to an electrotactile electrode of the touch input panel when the electrically conductive element is in proximity to the electrotactile electrode, capacitive coupling between the electrically conductive element and the electrotactile electrode configured to create vibrations in the tip of the apparatus to cause a variation in the frictional force between the tip and the touch input panel as perceived by a user gripping the shaft of the apparatus during relative lateral movement of the tip and touch input panel, the method comprising:
creating vibrations in the tip of the apparatus using capacitive coupling between the electrically conductive element and the electrotactile electrode, the vibrations created in the tip causing a variation in the frictional force between the tip and the touch input panel as perceived by a user gripping the shaft of the apparatus during relative lateral movement of the tip and touch input panel.

20. A computer program, recorded on a carrier, the computer program comprising computer code configured to control the method of claim 19.
